(19) United States
(12) Patent Application Publication
(10) Pub. No.: US 2007/0200838 A1
(43) Pub. Date: Aug. 30, 2007

(54) Image displaying apparatus having frame rate conversion and method thereof

(75) Inventors: Chang-Woo Lee, Suwon-si (KR); Moon-cheol Kim, Suwon-si (KR); Yoon-cheol Shin, Gangnam-gu (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/656,529

(22) Filed: Jan. 23, 2007

(30) Foreign Application Priority Data
Feb. 28, 2006 (KR) 10-2006-0019424

(51) Int. Cl. G09G 5/00

(52) U.S. Cl. 345/204

(57) ABSTRACT

Provided are an image display apparatus with a frame rate conversion function and a frame-rate conversion method thereof. The image displaying apparatus includes a frame rate conversion (FRC) part which converts and outputs a frame rate of an input image signal depending on a motion of an image, and a display which processes the input image signal that is output from the FRC part to display on a screen. Therefore, a motion judder can be decreased so that an image quality can be enhanced and power consumption can be reduced.

### CROSS-REFERENCE TO RELATED APPLICATIONS

This application claims the benefit of Korean Patent Application No. 10-2006-19424 filed on Feb. 28, 2006, in the Korean Intellectual Property Office, the disclosure of which is incorporated herein by reference.

### BACKGROUND OF THE INVENTION

1. Field of the Invention:

The present invention relates to an image displaying apparatus having a frame rate conversion function and a frame rate conversion method thereof. More particularly, the present invention relates to an image displaying apparatus with a frame rate conversion function that reduces a motion judder, which occurs in a mobile image displaying apparatus, so that a smooth image can be provided, and a frame rate conversion method thereof.

2. Description of the Related Art

Generally, a frame rate refers to the number of image signals displayed on a screen for one second, and the unit of the frame rate is Hz. A conventional image displaying apparatus such as a television or a monitor converts a frame rate of an image signal to provide a user with a smooth image quality in which a motion judder is reduced. The motion judder is generated by panning a camera during photographing operations.

In other words, if a frame rate of an image signal received from a video player or DVD player is different from a frame rate displayable at an image displaying apparatus, the frame rate can be converted to display an image signal on a screen. Additionally, in order to prevent occurrence of a motion judder for an image signal received from a video player or a DVD player, the frame rate is converted to display a smooth image on a screen.

Most conventional image displaying apparatuses with a frame rate conversion function do not have a mobile function. The frame rate conversion of the conventional image displaying apparatus without a mobile function will be explained with reference to FIGS. 1 and 2.

FIG. 1 is a view of a schematic structure of a general image displaying apparatus.

Referring to FIG. 1, a conventional image displaying apparatus comprises a frame buffer 10, a frame rate conversion (FRC) part 30, and a display 70.

The frame buffer 10 temporarily stores an image signal, and outputs an image signal with a certain frame rate to the FRC part 30. The FRC part 30 converts a frame rate of an image signal into a frame rate displayable at the display 70. Then, the display 70 processes an image signal to display on a screen.

The FRC part 30 converts and outputs a frame rate of an input image signal in order to remove a motion judder. In other words, if the frame rate of the input image signal is 15 Hz, the FRC part 30 converts and outputs the frame rate into 30 Hz, if the frame rate is 30 Hz, the FRC part 30 converts and outputs the frame rate into 60 Hz, if the frame rate is 50 Hz, the FRC part 30 converts and outputs the frame rate into 100 Hz, and if the frame rate is 60 Hz, the FRC part 30 converts and outputs the frame rate into 120 Hz. At this time, the frame compensated by a motion estimation is added to an original frame so that the frame rate of the input image signal can be converted and output at a double rate.

Even when the frame rate of the input image signal is different depending on a transmission scheme of the input image signal, the FRC part 30 converts and outputs the frame rate into that corresponding to a display scheme of the display 70. In other words, an image signal of 50 Hz which is input according to a phase alternation by line system (PAL) scheme, or an image signal of 24 Hz which is input according to a sequential Couleur a Memoire (SECAM) scheme is converted and output into an image signal of 60 Hz according to a national television system committee (NTSC) scheme corresponding to the display scheme of the display 70.

There is a limit to applying the frame rate conversion function to a mobile image displaying apparatus due to the characteristic of a mobile image displaying apparatus. In detail, an interpolated frame should be generated by a motion estimation to convert the frame rate as described with reference to FIG. 1, and a mobile image displaying apparatus has to perform a large amount of calculation to generate the interpolated frame.

However, the mobile image displaying apparatus has limited hardware resources for signal processing, and therefore, it cannot have a frame rate conversion function so that the entire quality of an image displayed on a screen is deteriorated.

The conventional mobile image displaying apparatus has an image quality improvement function to increase an image quality. This will be explained with reference to FIG. 2.

FIG. 2 is another view of a schematic structure of a conventional mobile image displaying apparatus.

Referring to FIG. 2, the conventional mobile image displaying apparatus comprises a decoder 20, an image quality improver 40, a Timing Controller (TCon) 60, and a display 70.

The decoder 20 decodes and outputs encoded image signal, and the image quality improver 40 outputs an image signal in which noise is removed or color characteristic increased. The noise is generated during decoding. Tcon 60 converts and outputs the frame rate of an image signal output from the image quality improver 40 into that of 60 Hz corresponding to the display scheme of the display 70.

The display 70 processes the image signal of 60 Hz to display on a screen so that an image with an improved quality can be provided to a user.

As described with reference to FIG. 2, the image quality improver 40 processes an image signal to remove noise for all frames included in an image signal output from the decoder 20, or improve a color characteristic. Due to the signal processing of the image quality improver 40, unnecessary power consumption occurs in a mobile image displaying apparatus.

### SUMMARY OF THE INVENTION

Accordingly, aspects of the present invention are to address at least the above problems. Therefore, an aspect of the present invention is to provide an image displaying apparatus with a frame rate conversion function that converts a frame rate of an input image signal by simplifying a motion estimation method so that a motion judder in a time axial direction can be reduced, wherein the motion judder is generated when a camera, photographing an image using limited hardware resources, is panning, and a frame rate conversion method thereof.

Another aspect of the present invention is to provide an image displaying apparatus that performs an image quality enhancement function depending on motion degrees in order to reduce power consumption.

To achieve the above-described object, there is provided an image displaying apparatus including a frame rate conversion (FRC) part which converts and outputs a frame rate of an input image signal depending on a motion of an image, and a display which processes the input image signal that is output from the FRC part to display on a screen.

The FRC part estimates a motion for a certain area of a present frame included in the input image signal, and if it is determined that a motion equal to or more than a predetermined reference exists in the certain area, converts and outputs a frame rate of the input image signal.

If it is determined that a motion equal to or more than a predetermined reference exists in the input image signal, the FRC part interpolates and outputs the input image signal.

The FRC part may include a partial motion estimator which calculates a motion vector for a certain area of a present frame included in the input image signal with a first frame rate and outputs a maximal value of accumulated values of the motion vector, a motion determiner which compares the maximal value with a first threshold value and if the maximal value is equal to or greater than the first threshold value, determines that a motion equal to or greater than a determined reference exists in the input image signal, an additional calculator which calculates a motion vector for a remaining area except for the certain area of the present frame depending on the determination result of the motion determiner, and a motion compensator which alternatively outputs the present frame and an interpolated frame of the present frame using the motion vector for the certain area and the motion vector for the remaining area so as to output the input image signal with a second frame rate.

If the maximal value is less than the first threshold value, the motion determiner outputs the input image signal with the first frame rate.

The partial motion estimator divides the present frame into a plurality of screen areas that consist of a predetermined number of blocks including N×M pixels and calculates a motion vector of a block included in the certain area that is a part of the plurality of screen areas.

According to an aspect of the invention, there is provided a frame rate conversion method of an image displaying apparatus having a display, the method including operations of converting and outputting a frame rate of an input image signal depending on a motion of an image, and processing the input image signal to display on a screen.

The operation of converting the frame rate estimates a motion for a certain area of a present frame included in the input image signal, and if it is determined that a motion equal to or more than a predetermined reference exists in the certain area, converts and outputs a frame rate of the input image signal.

If it is determined that a motion equal to or more than a predetermined reference exists in the input image signal, the operation of converting the frame rate interpolates and outputs the input image signal.

The operation of converting the frame rate includes operations of calculating a motion vector for a certain area of a present frame included in the input image signal with a first frame rate, outputting a maximal value of accumulated values of the motion vector, comparing the maximal value with a first threshold value and if the maximal value is equal to or greater than the first threshold value, determining that a motion equal to or greater than a determined reference exists in the input image signal, calculating a motion vector for a remaining area except for the certain area of the present frame depending on the determination result, and alternatively outputting the present frame and an interpolated frame of the present frame using the motion vector for the certain area and the motion vector for the remaining area so as to output the input image signal with a second frame rate.

If the maximal value is less than the first threshold value, the operation of converting the frame rate outputs the input image signal with the first frame rate.

The operation of calculating the motion vector for the certain area of the present frame included in the input image signal divides the present frame into a plurality of screen areas that consist of a predetermined number of blocks including N×M pixels and calculates a motion vector of a block included in the certain area that is a part of the plurality of screen areas.

According to an aspect of the invention, there is provided an image displaying apparatus including a frame rate conversion (FRC) part which converts and outputs a frame rate of an input image signal depending on a motion of an image, an image quality improver which processes and outputs the input image signal, that is output from the FRC part, to improve an image quality, and a display which processes the input image signal, an image quality of which is improved, to display on a screen.

The FRC part includes a motion estimator which calculates a motion vector for a present frame included in the input image signal with a first frame rate, a motion determiner which determines a motion degree of the input image signal using a distribution of accumulated values of the motion vector, and an output part which converts and outputs the input image signal with the first frame rate into the image signal with a certain frame rate depending on the determination result of the motion determiner.

If a maximal value of the accumulated values is not greater than a first threshold value in the distribution of the accumulated values of the motion vector, the motion determiner determines that a first motion degree exists in the input image signal.

If a maximal value of the accumulated values is greater than a first threshold value and the maximal value is not distributed in a second threshold area in a size area of the motion vector, the motion determiner determines that a second motion degree exists in the input image signal.

If a maximal value of the accumulated values is greater than a first threshold value and the maximal value is distributed in a second threshold area in a size area of the motion vector, the motion determiner determines that a third motion degree exists in the input image signal.

The first motion degree, the second motion degree, and the third motion degree satisfy the equation:

the third motion degree<the first motion degree<the second motion degree.

The output part includes a first output part which outputs the present frame so as to output the input image signal with a first frame rate, a second output part which interpolates the present frame to insert and output the interpolated frame between the present frame so as to output the input image signal with a second frame rate, and a third output part which deletes one frame in every two frames of the present frame so as to output the input image signal with a third frame rate.

The output part converts the first frame rate into the first frame rate, a second frame rate, which is double the first frame rate, and a third frame rate, which is ½ times of the first frame rate, depending on the determination result of the motion determiner.

According to an aspect of the invention, there is provided a frame rate conversion method of an image displaying apparatus having a display, the method including operations of converting and outputting a frame rate of an input image signal depending on a motion degree of an image, performing a signal processing for the input image signal to improve an image quality and outputting the signal, and processing the input image signal, the image quality of which is improved, to display on the display.

The operation of converting and outputting the frame rate includes operations of calculating a motion vector for a present frame included in the input image signal that is input with a first frame rate, determining a motion degree of the input image signal using a distribution of accumulated values of the motion vector, and converting and outputting the input image signal with the first frame rate into the image signal with a certain frame rate depending on the determination result.

If a maximal value of the accumulated values is not greater than a first threshold value in the distribution of the accumulated values of the motion vector, the operation of determining the motion degree determines that a first motion degree exists in the input image signal.

If a maximal value of the accumulated values is greater than a first threshold value and the maximal value is not distributed in a second threshold area in a size area of the motion vector, the operation of determining determines that a second motion degree exists in the input image signal.

If a maximal value of the accumulated values is greater than a first threshold value and the maximal value is distributed in a second threshold area in a size area of the motion vector, the operation of determining the motion degree determines that a third motion degree exists in the input image signal.

The operation of outputting the input image signal with the converted frame rate includes at least one of operations of outputting the present frame so as to output the input image signal with a first frame rate, interpolating the present frame to insert and output the interpolated frame between the present frame so as to output the input image signal with a second frame rate, and deleting one frame in every two frames of the present frame so as to output the input image signal with a third frame rate.

The operation of outputting the input image signal with the converted frame rate converts the first frame rate into a second frame rate, which is double the first frame rate, and a third frame rate, which is ½ times of the first frame rate, depending on the determination result of the motion determiner.

### BRIEF DESCRIPTION OF THE DRAWINGS

The above aspects and features of the present invention will be more apparent by describing certain embodiments of the present invention with reference to the accompanying drawings, in which:

FIG. 1 is a view illustrating a schematic structure of a general image displaying apparatus;

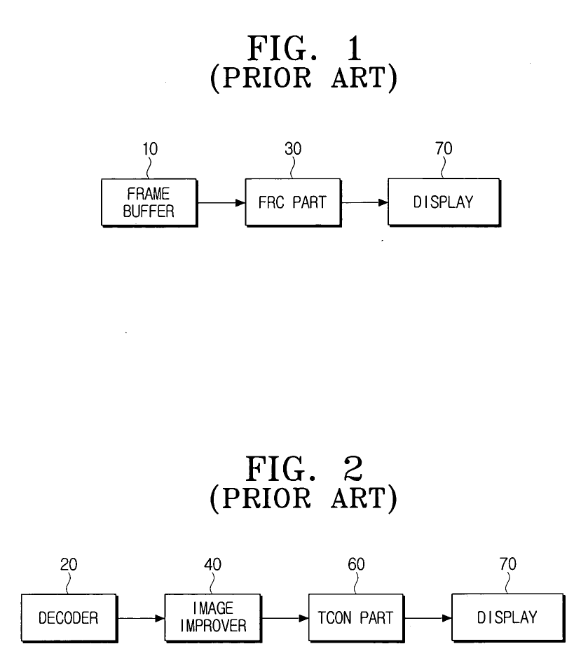

FIG. 2 is a view illustrating a schematic structure of a conventional mobile image displaying apparatus;

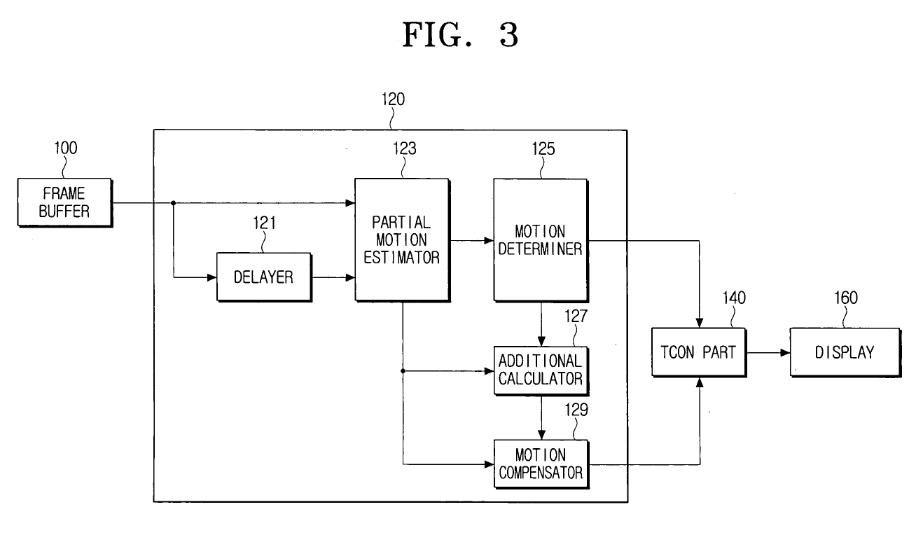

FIG. 3 is a view illustrating a schematic structure of an image displaying apparatus according to an exemplary embodiment of the present invention;

FIG. 4 is a view for explaining operations of a partial motion estimator of an image displaying apparatus according to an exemplary embodiment of the present invention;

FIGS. 5A and 5B are views for explaining operations of a motion determiner of an image displaying apparatus according to an exemplary embodiment of the present invention;

FIG. 6 is a flowchart of a frame rate conversion method of an image displaying apparatus according to an exemplary embodiment of the present invention;

FIG. 7 is a view illustrating a schematic structure of an image displaying apparatus according to another exemplary embodiment of the present invention;

FIGS. 8A through 8C are views for explaining operations of a motion determiner of an image displaying apparatus according to another exemplary embodiment of the present invention;

FIG. 9 is a view illustrating a frame rate of an image signal output from a frame rate conversion (FRC) part of an image displaying apparatus according to another exemplary embodiment of the present invention; and

FIG. 10 is a flowchart of a frame rate conversion method of an image displaying apparatus according to an exemplary embodiment of the present invention.

### DETAILED DESCRIPTION OF THE EXEMPLARY EMBODIMENTS

Exemplary embodiments of the present invention will be described in detail with reference to the annexed drawings. In the drawings, the same elements are denoted by the same reference numerals throughout the drawings. In the following description, detailed descriptions of known functions and configurations incorporated herein have been omitted for conciseness and clarity.

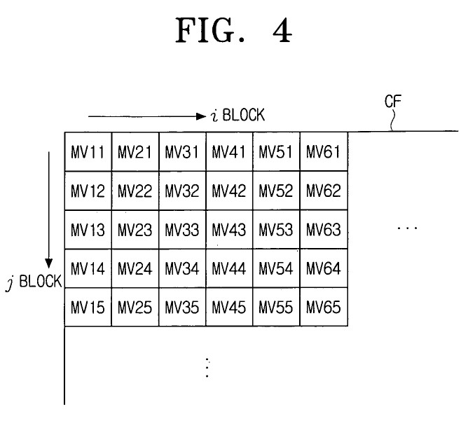

FIG. 3 is a view illustrating a schematic structure of an image displaying apparatus according to an exemplary embodiment of the present invention.

Referring to FIG. 3, an image displaying apparatus according to an exemplary embodiment of the present invention comprises a frame buffer 100, a frame rate conversion (FRC) part 120, a Timing Controller (Tcon) part 140, and a display 160.

The frame buffer 100 temporarily stores an image signal, which is transmitted to a mobile image displaying apparatus such as a digital multimedia broadcasting (DMB) signal and a personal multimedia player (PMP) signal, and the image signal stored in the frame buffer 100 is output with a first frame rate.

The FRC part 120 receives an image signal, output with the first frame rate from the frame buffer 100, and converts and outputs a frame rate of the received image signal depending on the motion of an image. In detail, depending on how much an image moves, the image signal is output with the first frame rate, or converted and output with a second frame rate, which is double the first frame rate. The FRC part 120 comprises a delayer 121, a partial motion estimator 123, a motion determiner 125, an additional calculator 127, and a motion compensator 129.

The delayer 121 delays the present frame output from the frame buffer 100 for a predetermined time to output a previous frame. The previous frame output from the delayer 121 is used as a reference frame for the partial motion estimator 123 to estimate a motion.

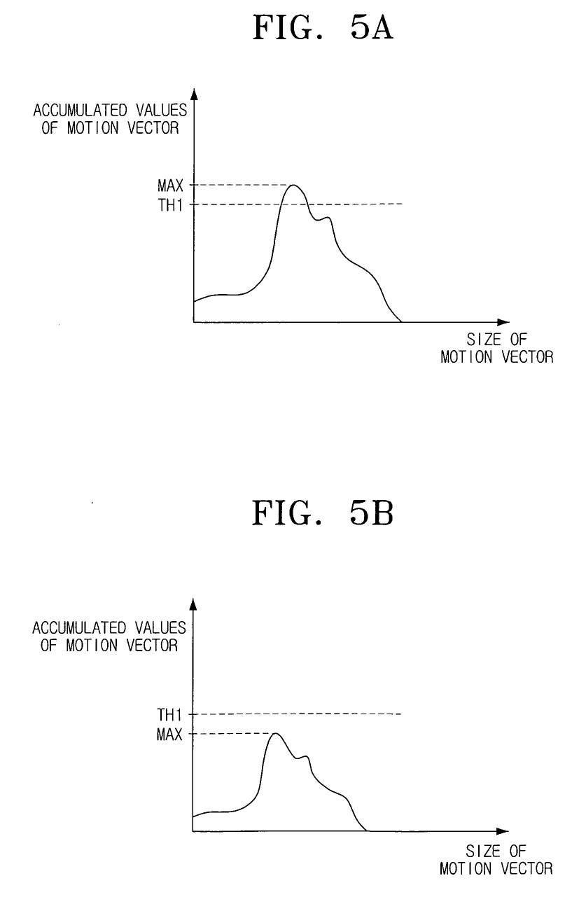

The partial motion estimator 123 simultaneously receives the present frame output from the frame buffer 100 and the previous frame output from the delayer 121, and then estimates a motion to calculate a motion vector. Here, the partial motion estimator 123 estimates a motion only for a certain area of the present frame, which will be elucidated with reference to FIG. 4. The partial motion estimator 123 calculates a motion vector for a certain area, and then outputs a maximal value as a parameter, wherein the maximal value refers to the accumulated values of the motion vector.

The motion determiner 125 determines whether a motion exists regarding the input image signal, using the parameter output from the partial motion estimator 123. In other words, if the parameter is equal to or greater than a first threshold value, the motion determiner 125 determines that a motion, which is equal to or greater than a certain reference, exists in the input image signal and transmits the determination result to the additional calculator 127. In other words, this is the case when a motion exists caused by panning a camera so that a motion judder occurs.

The additional calculator 127 estimates a motion for a remaining area except for a certain area of the present frame according to the determination result of the motion determiner 125 so as to calculate a remaining motion vector.

The motion compensator 129 interpolates the present frame using a motion vector for a certain area and a remaining motion vector for a remaining area of the present frame to generate an interpolated frame. The interpolated frame is output together with the present frame that is input to the partial motion estimator 123. Here, the present frame and the interpolated frame are output alternatively as 1:1 ratio from the motion compensator 129. In other words, an interpolated frame is output between each present frame.

By outputting the present frame and the interpolated frame, the FRC part 120 converts and outputs the first frame rate into the second frame rate of the input image signal.

If the parameter is less than the first threshold value, the motion determiner 125 determines that a motion equal to or greater than a predetermined reference does not exist in the input image signal. In other words, this is the case when a motion does not exist caused by panning a camera so that a motion judder does not occurs. Here, the motion determiner 125 outputs the present frame, input to the partial motion estimator 123, as the first frame rate as unchanged. In other words, the FRC part 120 does not convert the frame rate of the input image signal but outputs the input image signal as unchanged.

The TCon part 140 converts and outputs the frame rate of the image signal output from the FRC part 120 into that corresponding to a display scheme of the display 160.

The display 160 processes an image signal, the frame rate of which is converted by the TCon part 140, to display on a screen.

FIG. 4 is a view for explaining operations of a partial motion estimator 123 of an image displaying apparatus according to an exemplary embodiment of the present invention.

Referring to FIG. 4, the partial motion estimator 123 divides the present frame CF into a plurality of blocks consisting of N×M pixels. Here, N and M are natural numbers. As shown in FIG. 4, the partial motion estimator 123 estimates a motion for a certain area consisting of 6 (wide)×5 (long) blocks to calculate motion vectors MV11, MV21, . . . MV65 for a certain area. The location of the certain area can be adjusted.

The partial motion estimator 123 applies the following equation 1 to the motion vectors of the certain area to calculate a parameter, and provides the parameter to the motion determiner 125.

parameter=MAX[AVM(k+MV)],{−MV≦k<MV,min(MVᵢⱼ)≦MV≦max(MVᵢⱼ)} [Equation 1]

where, i refers to the number of blocks in a widthwise direction, j refers to the number of blocks in a lengthwise direction, and MV refers to a motion vector. The accumulation vector memory (AVM) refers to the motion vectors for a certain area that are accumulated and stored. Accordingly, the equation 1 refers to that the motion vectors are accumulated and a maximal value of the accumulated values is output as a parameter.

The equation 1 may be applied to the size of motion vector, x axis and y axis to calculate the maximal value as a parameter.

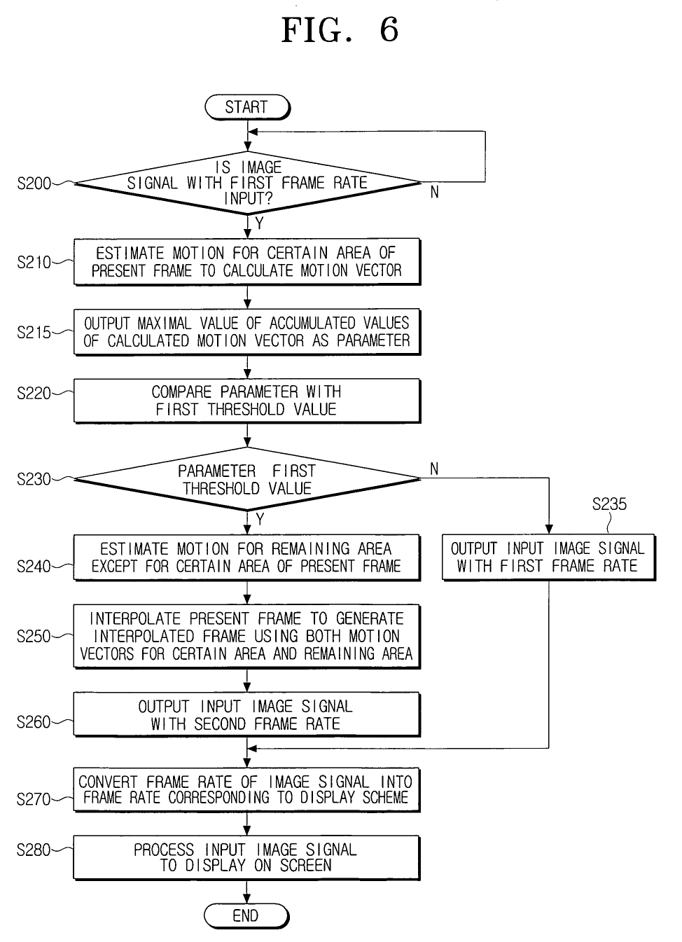

FIGS. 5A and 5B are views for explaining operations of a motion determiner of an image displaying apparatus according to an exemplary embodiment of the present invention.

As shown in FIG. 5A, if the maximal value MAX of accumulated values of the motion vectors is greater than the first threshold value TH1, the motion determiner 125 determines that a motion exists caused by a camera's panning. As shown in FIG. 5B, if the maximal value MAX of accumulated values of the motion vectors is less than the first threshold value TH1, the motion determiner 125 determines that a motion caused by a camera's rotation does not exist. Although not shown, if the maximal value MAX is identical with the threshold TH1, the motion determiner 125 determines that a motion exists caused by a camera's rotation.

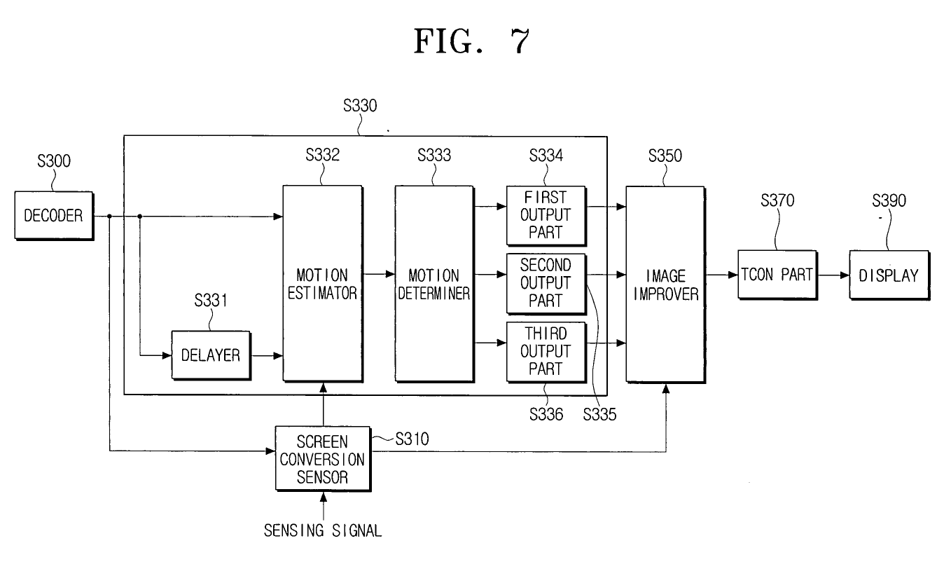

FIG. 6 is a flowchart of a frame rate conversion method of an image displaying apparatus according to an exemplary embodiment of the present invention.

Referring to FIG. 6, if the image signal of the first frame rate is received from the frame buffer 100 (S200), the partial motion estimator 123 estimates a motion for a certain area of the present frame to calculate a motion vector (S210). Additionally, the partial motion estimator 123 outputs the maximal value MAX of accumulated values of the calculated motion vector as a parameter (S215).

The motion determiner 125 compares the parameter with the first threshold value TH1 (S220), and if it is determined that the parameter is less than the first threshold value TH1 (S230), the motion determiner 125 outputs the present frame unchanged to output the input image signal as the first frame rate (S235). If the motion determiner 125 determines that the parameter is equal to or greater than the first threshold value TH1, the additional calculator 127 estimates a motion for a remaining area except for a certain area of the present frame to calculate a remaining motion vector (S240).

The motion compensator 129 interpolates the present frame using a motion vector for a certain area and a remaining motion vector for a remaining area of the present frame to generate an interpolated frame (S250), and then outputs the input image signal as the second frame rate (S260). In other words, the motion compensator 129 outputs an interpolated frame between each present frame so that the input image signal can be output as the second frame rate, which is a double of the first frame rate.

If an image signal with the first or second frame rate is output from the FRC part 120 as described above, the TCon part 140 converts the frame rate of the image signal into that corresponding to a display scheme (S270). The display 160 processes the image signal to display on a screen (S280).

By the above processes, the frame rate can be converted depending on a degree of motion and a motion judder based on a camera's panning can be decreased. Additionally, in the above explanation of the image displaying apparatus according to an exemplary embodiment of the present invention with reference to FIGS. 3 through 6, the first frame rate may be 30 Hz and the second frame rate may be 60 Hz.

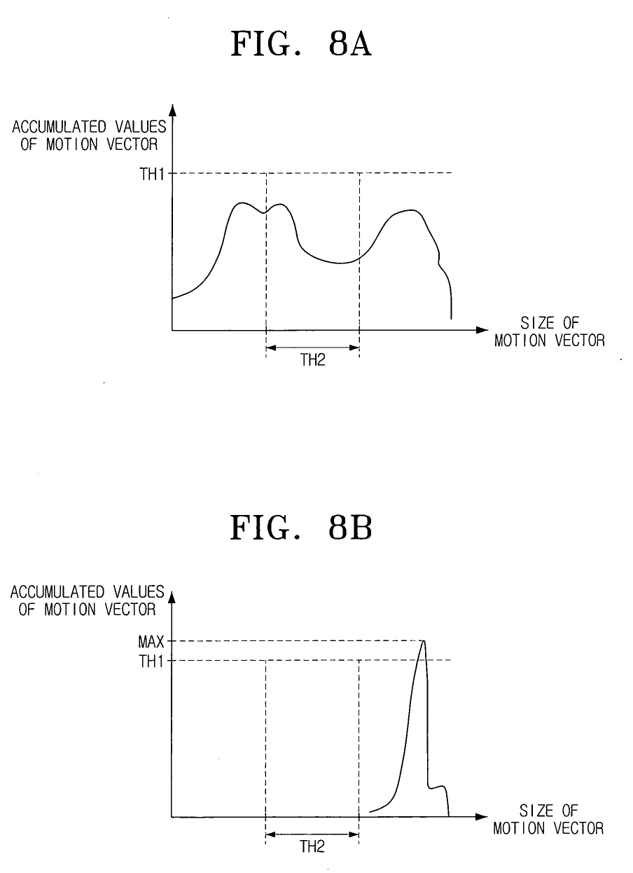

FIG. 7 is a view of a schematic structure of an image displaying apparatus according to another exemplary embodiment of the present invention.

Referring to FIG. 7, the image displaying apparatus according to another exemplary embodiment of the present invention comprises a decoder 300, a screen conversion sensor 310, a FRC part 330, an image quality improver 350, a TCon part 370, and a display 390.

The decoder 300 decodes and outputs an encoded input image signal. In detail, an image signal such as a DMB signal or a PMP signal, which is encoded and transmitted, is decoded, and a noise is generated in the image signal by the decoding operation of the decoder 300.

The screen conversion sensor 310 receives a sensing signal when an input image signal is significantly changed such as when a screen is converted to determine whether the screen is converted. Here, the screen conversion sensor 310 determines that a screen is converted for the input image signal, the present frame included in the input image signal is transmitted as the first frame rate to the image quality improver 350, which will be explained later. However, if the screen conversion sensor 310 determines that a screen is not converted for the input image signal, a control signal is transmitted to operate the FRC part 330, which will be explained later.

If a control signal regarding the case when the screen is not converted is received from the screen conversion sensor 310, the FRC part 330 receives an image signal of the first frame rate output from the decoder 300 and then converts and outputs the image signal into a signal with a predetermined frame rate, depending on a motion degree of the image. In other words, when the FRC part 330 outputs the image, the FRC part 330 does not convert the frame rate of the input image signal and maintains the frame rate as the first frame rate, converts the frame rate of the input image signal into the second frame rate, which is a double of the first frame rate, or converts the frame rate of the input image signal into the third frame rate, which is ½ times the first frame rate.

The FRC part 330 comprises a delayer 331, a motion estimator 332, a motion determiner 333, a first output part 334, a second output part 335, and a third output part 336.

The delayer 331 delays the present frame output from the decoder 300 for a predetermined time to output the previous frame. The previous frame output from the delayer 331 is used as a reference frame for the motion estimator 333 to estimate a motion.

The motion estimator 332 simultaneously receives the present frame output from the decoder 300 and the previous frame output from the delayer 331, and then estimates a motion and calculates a motion vector. The motion estimator 332 outputs one of a size, x-axial direction, and y-axial direction of the motion vector.

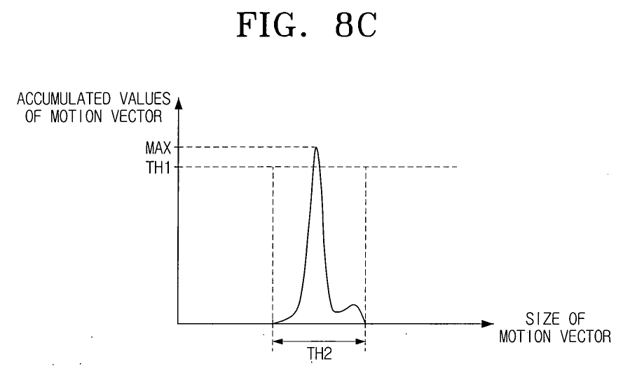

The motion determiner 333 determines an image motion using distribution of accumulated values of the motion vector output from the motion estimator 332. This will be elucidated with reference to FIGS. 8A through 8C.

The first output part 334 outputs the present frame depending on the determination result of the motion determiner 333 so as to output the input image signal with the first frame rate unchanged.

The second output part 335 interpolates the present frame to generate the interpolated frame, and outputs the present frame and the interpolated frame. At this time, the second output part 335 inserts the interpolated frame between the present frame to output the input image signal with the second frame rate. The second frame rate is double the first frame rate, and for example, if the first frame rate is 30 Hz, the second frame rate is 60 Hz.

The third output part 336 deletes one frame in every two frames of the present frame to output the input image signal with the third frame rate. The third frame rate is ½ times of the first frame rate, and for example, if the first frame rate is 30 Hz, the third frame rate is 15 Hz.

The FRC part 330 changes the frame rate of the input image signal depending on a motion degree of an image, to provide to the image quality improver 350.

The image quality improver 350 performs a signal processing such as noise reduction (NR) and color tone enhancement (CTE) regarding each frame output from the FRC part 330 to improve the image quality. In detail, the image improver 350 reduces noise, which is generated when an input image signal is decoded, or noise, which has existed since the input image signal was generated, and performs a signal process to increase color characteristic of image.

The TCon part 370 converts the frame rate of the image signal output from the FRC part 330 into the frame rate corresponding to a display scheme of the display 390 to output the image signal with the converted frame rate.

The display 390 processes the image signal with the converted frame rate to display it on a screen.

FIGS. 8A through 8C are views for explaining operations of the motion determiner 333 of an image displaying apparatus according to another exemplary embodiment of the present invention. FIGS. 8A through 8C show that the motion determiner 333 determines the motion degree using the size of the motion vector.

If a maximal value MAX is not greater than a first threshold value TH1 among the accumulated values of the motion vector as shown in FIG. 8A, the motion determiner 333 determines that motions appropriately exist in the input image signal. In other words, the motion determiner 333 determines that a first motion degree exists in the input image signal.

If a maximal value MAX is greater than a first threshold value TH1 among the accumulated values of the motion vector and a location of the maximal value MAX does not exist in a second threshold area TH2 as shown in FIG. 8B, the motion determiner 333 determines that very great motions exist in the input image signal. In other words, the motion determiner 333 determines that a second motion degree exists in the input image signal.

If a maximal value MAX is greater than a first threshold value TH1 among the accumulated values of the motion vector and a location of the maximal value MAX exists in a second threshold area TH2 as shown in FIG. 8C, the motion determiner 333 determines that motions hardly exist in the input image signal. In other words, the motion determiner 333 determines that a third motion degree exists in the input image signal.

Here, the first motion degree, the second motion degree, and the third motion degree satisfy following equation 2.

the third motion degree<the first motion degree<the second motion degree [Equation 2]

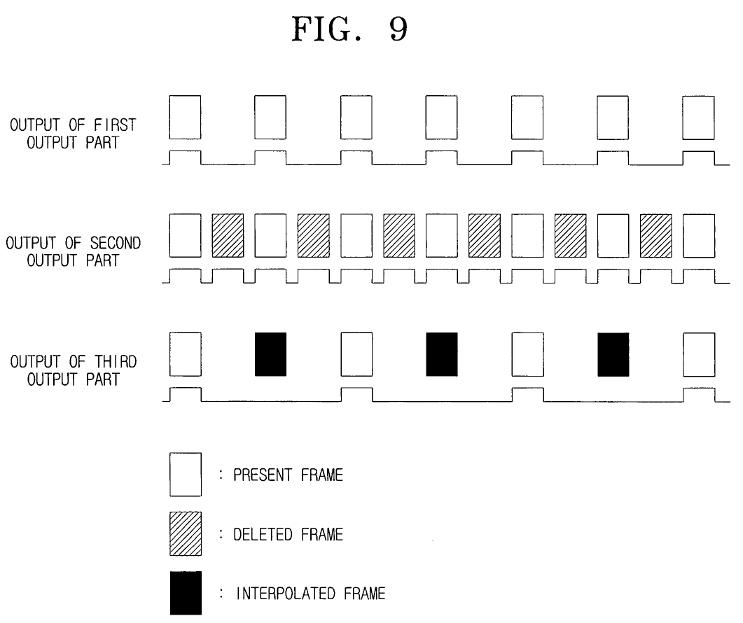

FIG. 9 is a view illustrating a frame rate of an image signal output from the FRC part 330 of an image displaying apparatus according to another exemplary embodiment of the present invention.

Referring to FIG. 9, from the first output part 334, an image signal is output with the first frame rate unchanged. The outputting is performed when the motion determiner 333 determines that the first motion degree exists in the image signal as described with reference to FIG. 8A.

From the second output part 335, an image signal is output with the second frame rate, wherein the present frame and the interpolated frame are alternatively output. The outputting is performed when the motion determiner 333 determines that the second motion degree exists in the image signal as described with reference to FIG. 8B.

From the third output part 336, an image signal is output with the third frame rate, wherein one deleted frame in every two frames is output. The outputting is performed when the motion determiner 333 determines that the third motion degree exists in the image signal as described with reference to FIG. 8C.

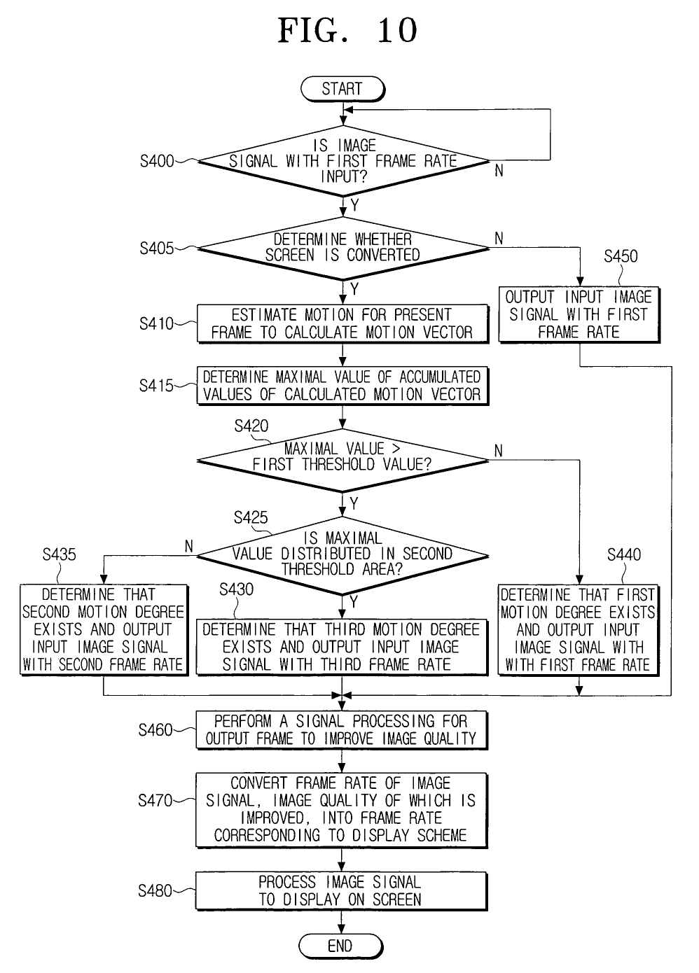

FIG. 10 is a flowchart of a frame rate conversion method of an image displaying apparatus according to another exemplary embodiment of the present invention.

Referring to FIG. 10, if an image signal with the first frame rate, which is decoded by the decoder 300, is input to the FRC part 330, the screen conversion sensor 310 determines whether the screen is converted (S405).

If the screen conversion sensor 310 determines that the screen is converted, the FRC part 330 transmits a corresponding control signal and the motion estimator 332 estimates a motion for the present frame to calculate a motion vector (S410). The motion determiner 333 decides a maximal value MAX of accumulated values of the calculated motion vector (S415) and compares the maximal value MAX with the first threshold value TH1 in magnitude (S420) so as to determine whether an area, where the maximal value MAX is distributed, is included in the second threshold area TH2 (S425).

If it is determined that the maximal value MAX is greater than the first threshold value TH1 and the distributed area is included in the second threshold area, the motion determiner 333 determines that the third motion degree exists in the input image signal and outputs the input image signal with the third frame rate (S430).

If it is determined that the maximal value MAX is greater than the first threshold value TH1 and the distributed area is not included in the second threshold area, the motion determiner 333 determines that the second motion degree exists in the input image signal and outputs the input image signal with the second frame rate (S435).

If it is determined that the maximal value MAX is not greater than the first threshold value TH1, the motion determiner 333 determines that the first motion degree exists in the input image signal and outputs the input image signal with the first frame rate (S440).

If the screen conversion sensor 310 determines that the screen is not converted in operation S405, the present frame is output with the first frame rate as unchanged (S450).

The image quality improver 350 performs a signal processing for the frame output from the FRC part 330 or the screen conversion sensor 310 to improve an image quality (S460). The TCon part 370 converts the frame rate of the image signal output from the image improver 350 into a frame rate corresponding to a display scheme (S470). The display 390 performs a signal processing to display on a screen (S480).

By the above processes, an image quality can be selectively improved depending on a motion degree of an input image.

According to exemplary embodiments of the present invention, the motion estimation method is simplified and the frame rate of the input image signal is converted arid output so that a motion judder in a time axial direction can be reduced and accordingly, an image quality can be improved. Additionally, an image quality can be selectively applied depending on a motion degree so that power consumption for improving an image quality can be reduced.

While the invention has been shown and described with reference to certain embodiments thereof, it will be understood by those skilled in the art that various changes in form and details may be made therein without departing from the spirit and scope of the invention as defined by the appended claims.

What is claimed is:

1. An image displaying apparatus comprising:
a frame rate conversion (FRC) part which converts a frame rate of an input image signal depending on a motion of an image and outputs the converted image signal; and
a unit which processes the input image signal that is output from the FRC part to display on a screen, wherein the FRC part estimates a motion for a certain area of a present frame included in the input image signal, and if it is determined that a motion equal to or more than a predetermined reference exists in the certain area, converts and outputs a frame rate of the input image signal.

2. The apparatus as claimed in claim 1, wherein if it is determined that a motion equal to or more than a predetermined reference exists in the input image signal, the FRC part interpolates and outputs the input image signal.

3. The apparatus as claimed in claim 1, wherein the FRC part comprises:
a partial motion estimator which calculates a motion vector for a certain area of a present frame included in the input image signal with a first frame rate and outputs a maximal value of accumulated values of the motion vector;
a motion determiner which compares the maximal value with a first threshold value and if the maximal value is equal to or greater than the first threshold value, which determines that a motion equal to or greater than a determined reference exists in the input image signal;
an additional calculator which calculates a motion vector for a remaining area other than the certain area of the present frame depending on the determination result of the motion determiner; and
a motion compensator which alternatively outputs the present frame and an interpolated frame of the present frame using the motion vector for the certain area and the motion vector for the remaining area so as to output the input image signal with a second frame rate.

4. The apparatus as claimed in claim 3, wherein if the maximal value is less than the first threshold value, the motion determiner outputs the input image signal with the first frame rate.

5. The apparatus as claimed in claim 3, wherein the partial motion estimator divides the present frame into a plurality of screen areas that consist of a predetermined number of blocks including N×M pixels and calculates a motion vector of a block included in the certain area that is a part of the plurality of screen areas.

6. A frame rate conversion method of an image displaying apparatus having a display, the method comprising:
converting a frame rate of an input image signal depending on a motion of an image and outputting the converted image signal; and
processing the converted image signal to display on a screen, wherein the operation of converting the frame rate estimates a motion for a certain area of a present frame included in the input image signal, and if it is determined that a motion equal to or more than a predetermined reference exists in the certain area, converts and outputs a frame rate of the input image signal.

7. The method as claimed in claim 6, wherein if it is determined that a motion equal to or more than a predetermined reference exists in the input image signal, the operation of converting the frame rate interpolates and outputs the input image signal.

8. The method as claimed in claim 6, wherein the operation of converting the frame rate comprises:
calculating a motion vector for a certain area of a present frame included in the input image signal with a first frame rate;
outputting a maximal value of accumulated values of the motion vector;
comparing the maximal value with a first threshold value and if the maximal value is equal to or greater than the first threshold value, determining that a motion equal to or greater than a determined reference exists in the input image signal;
calculating a motion vector for a remaining area other than the certain area of the present frame depending on the determination result; and
alternatively outputting the present frame and an interpolated frame of the present frame using the motion vector for the certain area and the motion vector for the remaining area so as to output the input image signal with a second frame rate.

9. The method as claimed in claim 8, further comprising, if the maximal value is less than the first threshold value, outputting the input image signal with the first frame rate.

10. The method as claimed in claim 8, wherein the operation of calculating the motion vector for the certain area of the present frame included in the input image signal divides the present frame into a plurality of screen areas that consist of a predetermined number of blocks including N×M pixels and calculates a motion vector of a block included in the certain area that is a part of the plurality of screen areas.

11. An image displaying apparatus comprising:
a frame rate conversion (FRC) part which converts and outputs a frame rate of an input image signal depending on a motion of an image;
an image quality improver which processes and outputs the input image signal, that is output from the FRC part, to improve an image quality; and
a display which processes the input image signal, an image quality of which is improved, to display on a screen.

12. The apparatus as claimed in claim 11, wherein the FRC part comprises:
a motion estimator which calculates a motion vector for a present frame included in the input image signal with a first frame rate;
a motion determiner which determines a motion degree of the input image signal using a distribution of accumulated values of the motion vector; and
an output part which converts and outputs the input image signal with the first frame rate into the image signal with a certain frame rate depending on the determination result of the motion determiner.

13. The apparatus as claimed in claim 12, wherein if a maximal value of the accumulated values is not greater than a first threshold value in the distribution of the accumulated values of the motion vector, the motion determiner determines that a first motion degree exists in the input image signal.

14. The apparatus as claimed in claim 12, wherein if a maximal value of the accumulated values is greater than a first threshold value and the maximal value is not distributed in a second threshold area in a size area of the motion vector, the motion determiner determines that a second motion degree exists in the input image signal.

15. The apparatus as claimed in claim 12, wherein if a maximal value of the accumulated values is greater than a first threshold value and the maximal value is distributed in a second threshold area in a size area of the motion vector, the motion determiner determines that a third motion degree exists in the input image signal.

16. The apparatus as claimed in claim 13, wherein the first motion degree, the second motion degree, and the third motion degree satisfy an equation:
the third motion degree<the first motion degree<the second motion degree.

17. The apparatus of claim 14, wherein the first motion degree, the second motion degree, and the third motion degree satisfy an equation:
the third motion degree<the first motion degree<the second motion degree.

18. The apparatus of claim 15, wherein the first motion degree, the second motion degree, and the third motion degree satisfy an equation:
the third motion degree<the first motion degree<the second motion degree.

19. The apparatus as claimed in claim 12, wherein the output part comprises:
a first output part which outputs the present frame so as to output the input image signal with a first frame rate;
a second output part which interpolates the present frame to insert and output the interpolated frame after the present frame so as to output the input image signal with a second frame rate; and
a third output part which deletes one frame in every two frames of the present frame so as to output the input image signal with a third frame rate.

20. The apparatus as claimed in claim 12, wherein the output part converts the first frame rate into the first frame rate, a second frame rate, which is double the first frame rate, and a third frame rate, which is ½ times the first frame rate, depending on the determination result of the motion determiner.

21. A frame rate conversion method of an image displaying apparatus having a display, the method comprising:
converting a frame rate of an input image signal depending on a motion degree of an image and outputting a converted signal;
performing a signal processing on the converted signal to improve an image quality and outputting a processed signal; and
displaying the processed signal on the display.

22. The method as claimed in claim 21, wherein the operation of converting and outputting the frame rate comprises:
calculating a motion vector for a present frame included in the input image signal that is input with a first frame rate;
determining a motion degree of the input image signal using a distribution of accumulated values of the motion vector; and
converting the input image signal with the first frame rate into the converted image signal with a certain frame rate depending on the determination result.

23. The method as claimed in claim 22, wherein if a maximal value of the accumulated values is not greater than a first threshold value in the distribution of the accumulated values of the motion vector, the operation of determining the motion degree determines that a first motion degree exists in the input image signal.

24. The method as claimed in claim 22, wherein if a maximal value of the accumulated values is greater than a first threshold value and the maximal value is not distributed in a second threshold area in a size area of the motion vector, the operation of determining determines that a second motion degree exists in the input image signal.

25. The method as claimed in claim 22, wherein if a maximal value of the accumulated values is greater than a first threshold value and the maximal value is distributed in a second threshold area in a size area of the motion vector, the operation of determining the motion degree determines that a third motion degree exists in the input image signal.

26. The method as claimed in claim 23; wherein the first motion degree, the second motion degree, and the third motion degree satisfy an equation:
the third motion degree<the first motion degree<the second motion degree.

27. The method as claimed in claim 24, wherein the first motion degree, the second motion degree, and the third motion degree satisfy an equation:
the third motion degree<the first motion degree<the second motion degree.

28. The method as claimed in claim 25, wherein the first motion degree, the second motion degree, and the third motion degree satisfy an equation:
the third motion degree<the first motion degree<the second motion degree.

29. The method as claimed in claim 22, wherein the operation of outputting the input image signal with the converted frame rate comprises at least one of:
outputting the present frame so as to output the input image signal with a first frame rate;
interpolating the present frame to insert and output the interpolated frame between the present frame so as to output the input image signal with a second frame rate; and
deleting one frame in every two frames of the present frame so as to output the input image signal with a third frame rate.

30. The method as claimed in claim 22, wherein the operation of outputting the input image signal with the converted frame rate converts the first frame rate into a second frame rate, which is double the first frame rate, and a third frame rate, which is ½ times the first frame rate, depending on the determination result of the motion determiner.
